(19) United States
(12) Patent Application Publication
(10) Pub. No.: US 2024/0424662 A1
(43) Pub. Date: Dec. 26, 2024

(54) MULTI-CONFIGURATION MECHANIC'S CREEPER

(71) Applicant: MVP (H.K.) Industries Limited, Hong Kong (CN)

(72) Inventor: Victor Hung, Taipei City (TW)

(73) Assignee: MVP (H.K.) Industries Limited, Hong Kong (CN)

(21) Appl. No.: 18/339,676

(22) Filed: Jun. 22, 2023

(51) Int. Cl. B25H 5/00

(52) U.S. Cl. CPC B25H 5/00

(57) ABSTRACT

A creeper includes a first frame assembly and a second frame assembly that is rotatably coupled at a first end to a first end of the first frame assembly about a first axis. A third frame assembly is rotatably coupled at a first end to a second end of the second frame assembly about a second axis. The creeper further includes a biasing element operatively associate with the second and third frame assemblies. Rotation of the second frame assembly about the first axis in a first direction and rotation of the third frame about the second axis in a second direction opposite the first direction moves the creeper from a first configuration to a second configuration. The biasing element urges the third frame assembly to rotate in the second direction.

### BACKGROUND

In the field of auto mechanics, a mechanic is often required to work on the underside of a vehicle while performing maintenance or repair. Devices called creepers are widely used to mobilize a mechanic while working under a vehicle. Creepers generally allow the mechanic to move freely in a supine position and to work underneath the vehicle while allowing for minimal clearance under the vehicle. In that regard, creepers generally include a flat platform mounted on wheels or casters.

Some creepers allow the flat platform of the creeper to be transformed into different configurations, such as a “rolling seat” for working around the vehicle's exterior, rather than just underneath the vehicle's chassis. Such mechanic's creepers are usually foldable, thus allowing the creeper to be collapsed into a compact closed configuration which can be easily stored around the work area. However, these creepers typically require locking pins or other components to secure the creeper in one or both of the “flat” or “folded” configurations. Further, the inclusion of multiple independent hinges can make moving the creeper between the configurations unwieldy, so that doing so typically requires two hands.

The apparatus of the present disclosure provides the mechanic with an easily transformable mechanic's creeper that can be moved easily into various configurations with minimal effort using only one hand.

### SUMMARY

Embodiments of a mechanic's creeper are set forth below according to technologies and methodologies of the present disclosure. These creepers are configured to reciprocate between a first configuration, in which the creeper provides a flat surface that supports a supine user, and a second configuration, in which the creeper provides an elevated surface for sitting. A biasing element applies biasing forces to components of the creeper to assist movement of the creeper between the first and second configurations.

A first representative embodiment of a creeper A creeper includes a first frame assembly and a second frame assembly that is rotatably coupled at a first end to a first end of the first frame assembly about a first axis. A third frame assembly is rotatably coupled at a first end to a second end of the second frame assembly about a second axis. The creeper further includes a biasing element operatively associate with the second and third frame assemblies. Rotation of the second frame assembly about the first axis in a first direction and rotation of the third frame about the second axis in a second direction opposite the first direction moves the creeper from a first configuration to a second configuration. The biasing element urges the third frame assembly to rotate in the second direction.

In any embodiment, the first frame assembly, the second frame assembly, and the third frame assembly are parallel when the creeper is in the first configuration.

In any embodiment, the third frame assembly is positioned above and parallel to the third frame assembly when the creeper is in the second configuration.

In any embodiment, the creeper has a flat profile in the first configuration and a Z-shaped profile in the second configuration.

In any embodiment, the first frame assembly includes a first support surface that engages the second frame assembly when the creeper is in the second configuration, engagement of the first support surface with the second frame assembly preventing rotation of the second frame assembly in the first direction about the first axis.

In any embodiment, the first frame assembly includes a first support member fixedly coupled to a first frame, the first support surface forming part of the first support member.

In any embodiment, the second frame assembly engages the first support member when the creeper is in the first configuration, engagement of the second frame assembly with the first support member preventing rotation of the second frame assembly in the second direction.

In any embodiment, the second frame assembly includes a second support surface that engages the third frame assembly when the creeper is in the second configuration, engagement of the second support surface with the third frame assembly preventing rotation of the third frame assembly in the second direction about the second axis.

In any embodiment, the second frame assembly includes a second support member fixedly coupled to a second frame, the second support surface forming part of the second support member.

In any embodiment, the third frame assembly engages the second support member when the creeper is in the first configuration, engagement of the third frame assembly with the support member preventing rotation of the third frame assembly in the first direction.

In any embodiment, the second frame assembly includes a support surface that engages the third frame assembly when the creeper is in the second configuration, engagement of the support surface with the third frame assembly preventing rotation of the third frame assembly in the second direction about the second axis.

In any embodiment, the second frame assembly includes a support member fixedly coupled to a second frame, the support surface forming part of the support member, wherein the third frame assembly engages the support member when the creeper is in the first configuration, engagement of the third frame assembly with the support member preventing rotation of the third frame assembly in the first direction about the second axis.

In any embodiment, the second frame assembly includes a first spring interface, the third frame assembly includes a second spring interface, and the biasing element is a tension spring coupled at one end to the first spring interface and at a second end to the second spring interface.

In any embodiment, movement of the creeper from the first configuration to the second configuration stretches the tension spring.

In any embodiment, the tension spring is at a natural length when the creeper is in the second configuration.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is an isometric view of an exemplary embodiment of a multi-configuration mechanic's creeper shown in a first configuration;

FIG. 2 is a side elevational view thereof;

FIG. 3 is a bottom plan view thereof;

FIG. 4 is an isometric view of a second configuration of the multi-configuration mechanic's creeper of FIG. 1;

FIG. 5 is a side elevational view thereof;

FIG. 6 is a partial cross-sectional view of the first configuration of the multi-configuration mechanic's creeper as indicated in FIG. 3;

FIG. 7 is a partial cross-sectional of the second configuration thereof;

FIG. 8 is a partial cross-sectional view of the first configuration of the multi-configuration mechanic's creeper as indicated in FIG. 3;

FIG. 9 is a partial cross-sectional view of the second configuration thereof;

FIG. 10 is a partial bottom plan view of the first configuration of the multi-configuration mechanic's creeper as indicated in FIG. 8;

FIG. 11 is a partial cross-sectional view of the second configuration of the multi-configuration mechanic's creeper as indicated in FIG. 9;

FIG. 12 is a partial side view of showing the motion of a third frame assembly relative to a second frame assembly as the multi-configuration mechanic's creeper moves between the first and second configurations;

FIG. 13 is a graphical representation of characteristics of biasing elements coupled to the second and third frame assemblies as the multi-configuration mechanic's creeper moves between the first and second configurations;

FIG. 14 shows a side elevational view of a multi-configuration mechanic's creeper as it moves from a flat configuration to a folded configuration; and

FIG. 15 shows a side elevational view of the multi-configuration mechanic's creeper of FIG. 1 as it moves from the first (flat) configuration of FIG. 1 to the second (folded) configuration of FIG. 4.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

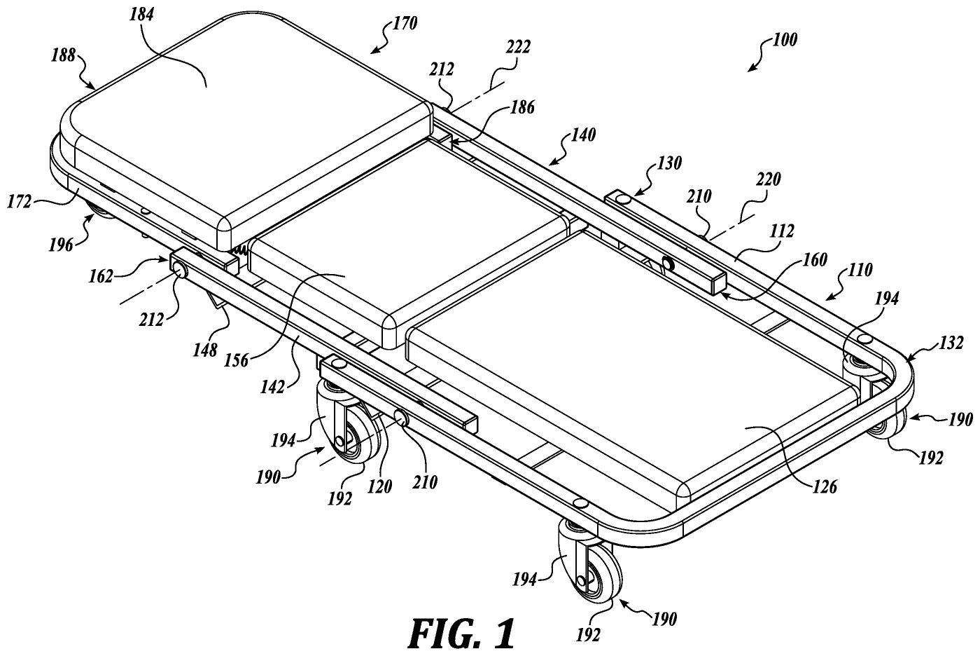

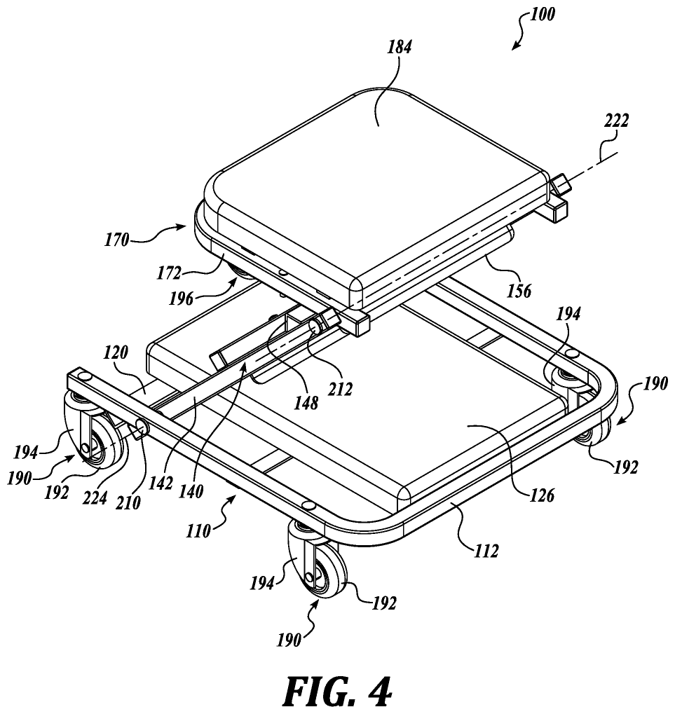

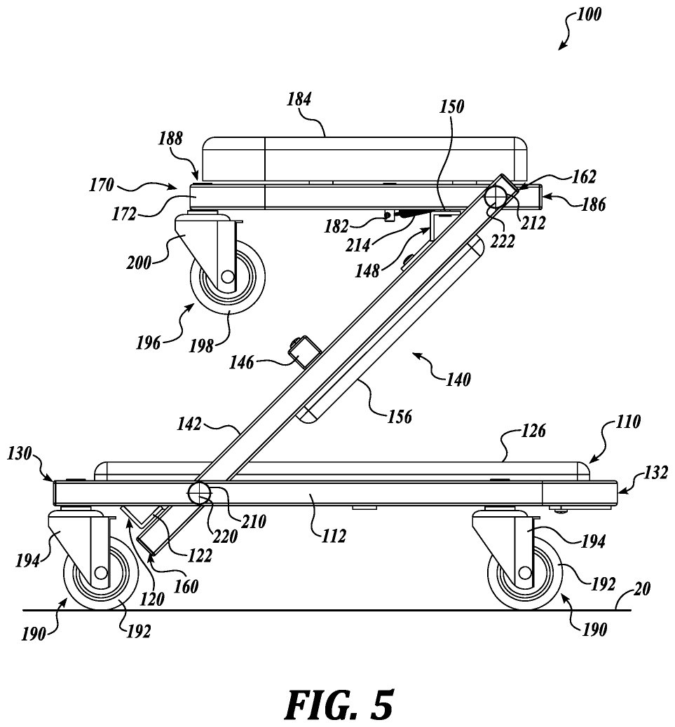

FIGS. 1-5 show a representative embodiment of a multi-configuration mechanic's creeper 100 (hereinafter “creeper” or “creeper 100”) according to aspects of the present disclosure. The creeper 100 in selectively moveable between a first configuration, shown in FIGS. 1-3 and a second configuration, shown in FIGS. 4 and 5. In the first configuration, the creeper 100 provides a low-profile apparatus to support a supine user. In the second configuration, the creeper 100′ provides an elevated surface upon which a user can sit. In both configurations, a plurality of rollers enable a user to move the creeper 100 along the support surface in any direction.

In general, the creeper 100 includes a first frame assembly 110 rotatably coupled to a second frame assembly 140. The second frame assembly 140 is also rotatably coupled to a third frame assembly 170. As will be described in further detail below, the rotational connection of the frame assemblies enables the creeper 100 to move between the first and second configurations.

The first frame assembly 110 has a first end 130 opposite a second end 132. The first frame assembly 110 includes a U-shaped frame 112 having substantially parallel elongate side portions 114 connected by an end portion 116, wherein the end portion 116 is positioned proximate to the first end 130 of the first frame assembly 110, and the open end of the frame 112 is located proximate to the second end 132 of the first frame assembly 110. The frame 112 is of any configuration (cross-sectional shape, contour, length, material, etc.) suitable for the intended application. In the depicted embodiment, the frame 112 has a unitary construction formed from elongated tubular structure, optionally having a hollow interior, composed of a suitably durable yet sufficiently lightweight material such as aluminum.

An elongate support member 120 is coupled to the free ends of the side portions 114, i.e., the ends opposite the end portion 116. The support member 120 is generally parallel to the end portion 116 of the frame 112. In the illustrated embodiment, the support member 120 has a cross-sectional profile with two legs forming an angle of approximately 90 degrees. As will be described in further detail, the support member 120 defines a support surface 112 that maintains the position of the second frame assembly 140 relative to the first frame assembly 110 when the creeper 100 is in the second configuration.

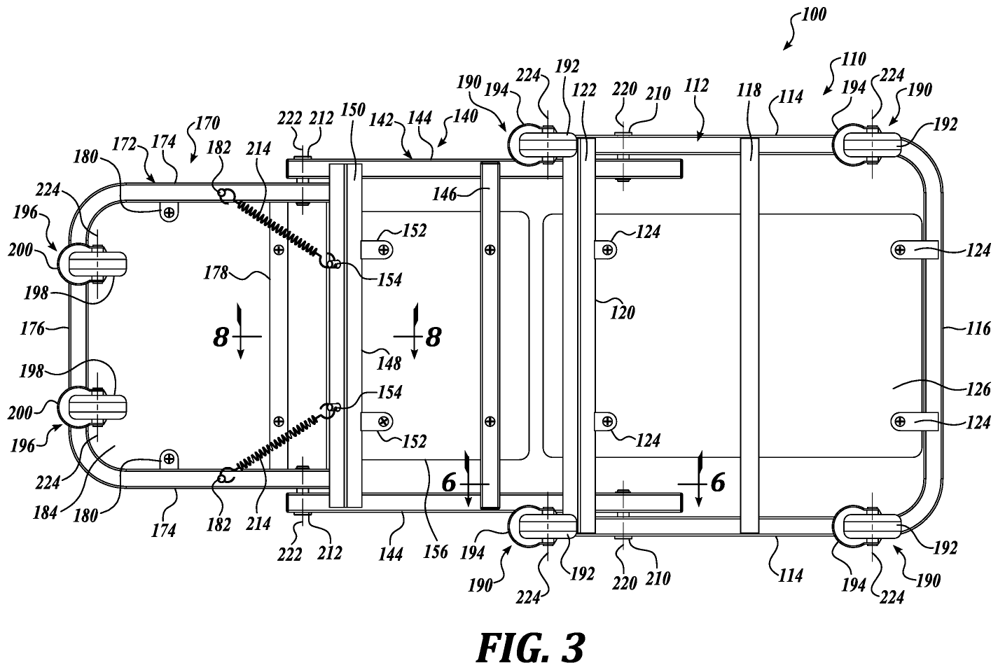

As best shown in FIG. 3, an elongate cross-member 118 extends between and is coupled to the side portions 114 of the frame 112. The cross-member 118 is parallel to the end portion 116 of the frame 112 and the support member 120 and is positioned approximately midway therebetween. The cross-member 118 is coupled to the frame by fasteners, welding, adhesives, or any other suitable means. In any embodiment, the cross-member 118 is integrally formed with the frame 112. In any embodiment, cross-member(s) 118 can be of any suitable number, position, orientation, material, cross-sectional shape, etc.

Referring again to FIGS. 1-5, a plurality of first wheel assemblies 190 are mounted to the frame 112. Each of the first wheel assemblies 190 includes a wheel support 194 extending downward from the bottom of the frame 112 and being rotatable about a vertical axis 226. A wheel 192 is rotatably mounted to each wheel support 194 about a horizontal axis 224. Thus, each of the first wheel assemblies 190 functions as a swivel caster. When the creeper 100 is in the first configuration of FIGS. 1-3, the first wheel assemblies 190 cooperate to support the first frame assembly 110 on a working surface 20, i.e., the ground, floor, etc., while allowing the first frame assembly 110 to roll in any direction along the working surface. When the creeper 100 is in the second configuration of FIGS. 4 and 5, the first wheel assemblies 190 fully support the creeper while allowing the first frame assembly 110 to roll in any direction along the working surface.

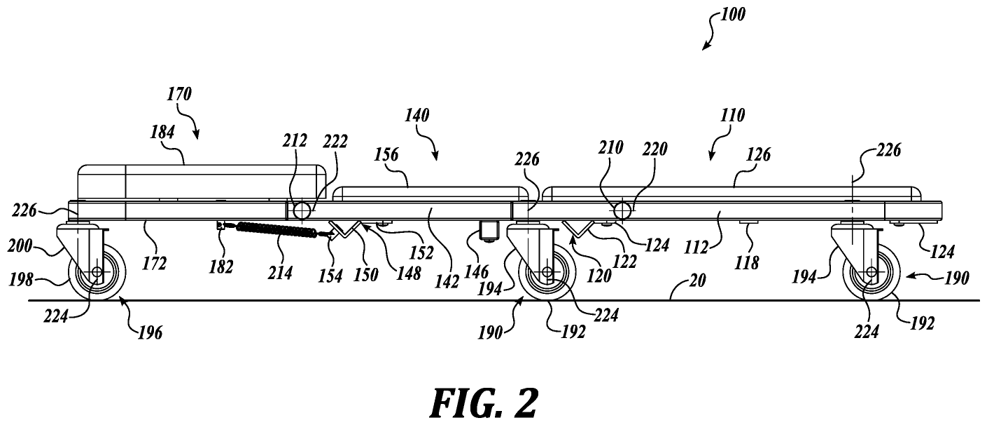

A first support pad 126 is mounted to one or more of the frame 112, the cross-member 118, and the support member 120. As best shown in FIG. 3, a plurality of support elements 124 extend inwardly from the frame 112 and the cross-member 118. The support elements 124 supportingly engage the first support pad 126 and are coupled thereto with fasteners. Referring to FIG. 2, the first support pad 126 provides a generally planar padded surface that is offset from the frame 112 in the vertical direction. As will be discussed in further detail, the first support pad 112 forms part of a surface upon which a user can work in a supine position while the creeper 100 is in the first configuration.

Referring again to FIGS. 1-5, the second frame assembly 140 has a first end 160 opposite a second end 162. The second frame assembly 140 includes a frame 142 that has a pair of elongate side portions 144 coupled together by a cross-member 146 and a support member 148. Each side portion 144 is an elongate member having any configuration (cross-sectional shape, contour, length, material, etc.) suitable for the intended application. In the depicted embodiment, each side portion 144 is formed from elongated tubular structure, optionally having a hollow interior, composed of a suitably durable yet sufficiently lightweight material such as aluminum. The elongate side portions 144 are straight, parallel to each other, and spaced apart so as to fit between the side portions 114 of the frame 112 of the first frame assembly. In some embodiments, the side portions 144 are contoured. In some embodiments, the side portions 144 are arranged about a central plane of symmetry.

As best shown in FIG. 3, the cross-member 146 extends between and is coupled to the side portions 144. The cross-member 146 is perpendicular to the side portions 144 and is positioned approximately midway between the first end 160 and the second end 162 of the second frame assembly 140. The cross-member 146 is coupled to each side portion 144 by fasteners, welding, adhesives, or any other suitable means. In any embodiment, the cross-member 146 is integrally formed with one or both side portions 144. In any embodiment, cross-member(s) 146 can be of any suitable number, position, orientation, material, cross-sectional shape, etc.

An elongate support member 148 is coupled to the second end 162 of each side portion 144. The support member 148 is generally perpendicular to the side portions 162. In the illustrated embodiment, the support member 148 has a cross-sectional profile with two legs forming an angle of approximately 90 degrees. As will be described in further detail, the support member 148 defines a support surface 150 that maintains the position of the third frame assembly 170 relative to the second frame assembly 140 when the creeper 100 is in the second configuration.

A second support pad 156 is mounted to one or more of the frame 142, the cross-member 116, and the support member 148. As best shown in FIG. 3, a pair of support elements 152 extend from the support member 140 in the direction of the cross-member 146. The support elements 152 and the cross-member 146 supportingly engage the second support pad 156 and are coupled thereto with fasteners. Referring to FIG. 2, the second support pad 156 provides a generally planar padded surface that is offset from the frame 142 in the vertical direction when the creeper 110 is in the first configuration. As will be discussed in further detail, the second support pad 156 forms part of a surface upon which a user can work in a supine position while the creeper 100 is in the first configuration.

The third frame assembly 170 has a first end 186 opposite a second end 188. The first frame assembly 170 includes a U-shaped frame 172 having substantially parallel elongate side portions 174 connected at the second end 188 of the third frame assembly 170 by an end portion 176. The open end of the frame 172, which is located at the first end 186 of the third frame assembly, is positioned proximate to the second end 162 of the second frame assembly 140. The frame 172 can be of any configuration (cross-sectional shape, contour, length, material, etc.) suitable for the intended application. In the depicted embodiment, the frame 112 has a unitary construction and is formed from elongated tubular structure, optionally having a hollow interior, composed of a suitably durable yet sufficiently lightweight material such as aluminum.

As best shown in FIG. 3, an elongate cross-member 178 extends between and is coupled to the side portions 174 of the frame 172. The cross-member 178 is parallel to the end portion 176 of the frame 172 and is positioned proximate to the first end 186 of the third frame assembly 170. The cross-member 178 is coupled to the frame by fasteners, welding, adhesives, or any other suitable means. In any embodiment, the cross-member 178 is integrally formed with the frame 172. In any embodiment, cross-member(s) 178 can be of any suitable number, position, orientation, material, cross-sectional shape, etc.

Referring again to FIGS. 1-5, a pair of second wheel assemblies 196 are mounted to second end 188 of the frame 172. Each of the second wheel assemblies 196 includes wheel support 200 extending downward from the bottom of the frame 172 and being rotatable about a vertical axis 226. A wheel 198 is rotatably mounted to each wheel support 200 about a horizontal axis 224. Thus, each of the second wheel assemblies 196 functions as a swivel caster. When the creeper is in the first configuration of FIGS. 1-3, the second wheel assemblies 190 cooperate to support the third frame assembly 170 on a working surface, i.e., the ground, floor, etc., while allowing the third frame assembly 170 to roll in any direction along the working surface.

A third support pad 184 is mounted to one or more of the frame 172, the cross-member 178, and the support member 148. As best shown in FIG. 3, a plurality of support elements 152 extend inwardly from the frame 172 and the cross-member 178. The support elements 152 supportingly engage the third support pad 184 and are coupled thereto with fasteners. Referring to FIG. 2, the third support pad 184 provides a generally planar padded surface that is offset from the frame 172 in the vertical direction. As will be discussed in further detail, the third support pad 184 forms part of a surface upon which a user can work in a supine position while the creeper 100 is in the first configuration. When the creeper 100 is in the second configuration, the third support pad 184 provides an elevated surface upon which a user can sit.

As previously noted, the first frame assembly 110 is rotatably coupled to the second frame assembly 140. More specifically, the first end 130 of the first frame assembly 110 is rotatably coupled about an axis 220 to the first end 160 of the second frame assembly 140. In the illustrated embodiment, each side portion 114 of the frame 112 of the first frame assembly 110 is located proximate to a corresponding side portion 144 of the frame 142 of the second frame assembly 140. On each side of the creeper 100, a pin 210 extends through the side portion 114 of the first frame assembly 110 and the side portion 144 of the second frame assembly 140. The pins 210 are coaxial with axis 220 so that the first frame assembly 110 and second frame assembly 140 are rotatable relative to each other about axis 220. It will be appreciated that the illustrated embodiment is exemplary only and should not be considered limiting. In this regard, the first frame assembly 110 can be rotatably coupled to the second frame assembly 140 by any suitable configuration, and such configurations should be considered within the scope of the present disclosure.

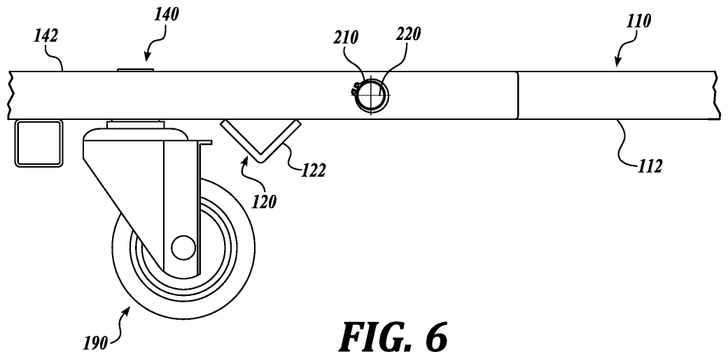

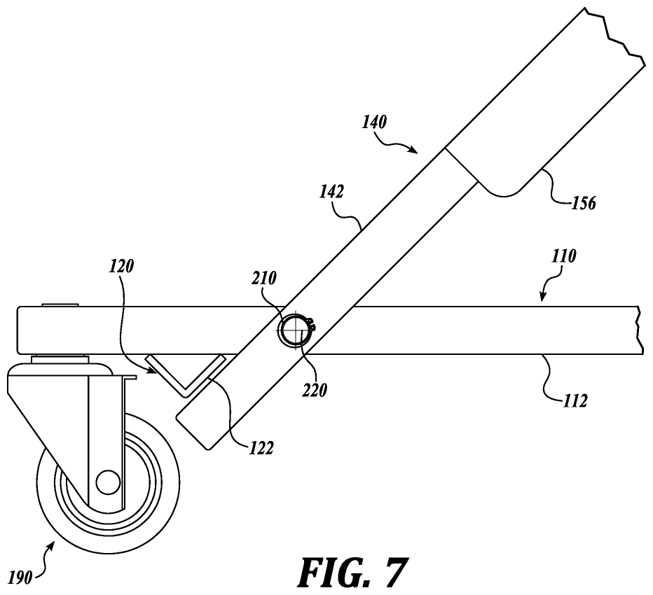

As shown in FIGS. 6 and 7, rotation of the first frame assembly 110 and the second frame assembly 140 relative to each other is limited. FIG. 6 shows a side view of the rotational connection of the first frame assembly 110 and the second frame assembly 140 when the creeper is in the first configuration of FIGS. 1-3. As shown in FIG. 6, the support member 120 of the first frame assembly 110, which is fixedly secured to the side portions 114 of the frame 112, engages the frame 142 of the second frame assembly 140 when the creeper 100 is in the first configuration. This engagement prevents the second frame assembly 140 from rotating in the counter-clockwise direction (as shown in FIGS. 6 and 7) about axis 220 relative to the first frame assembly 110. The second frame assembly 140 remains rotatable in the clockwise direction (as shown in FIGS. 6 and 7) about axis 220 relative to the first frame assembly 110 to transition the creeper 100 from the first configuration to the second configuration.

As the creeper 100 transitions from the first configuration (FIG. 6) to the second configuration (FIG. 7), the first frame assembly 110 continues to be supported by the work surface 20 (floor, ground, etc.) in a generally horizontal position. The second frame assembly 140 rotates in the clockwise direction relative to the first frame assembly 110 until the side portions 144 of the frame 142 of second frame assembly 140 engage the support surface 122 of the support element 120. With the frame 142 engaging the support surface 122, further rotation of the second frame assembly 140 in the clockwise direction is prevented.

The second frame assembly 140 is also rotatably coupled to the third frame assembly 170. More specifically, the first end 186 of the third frame assembly 170 is rotatably coupled about an axis 222 to the second end 162 of the second frame assembly 140. In the illustrated embodiment, each side portion 174 of the frame 172 of the third frame assembly 170 is located proximate to a corresponding side portion 144 of the frame 142 of the second frame assembly 140. On each side of the creeper 100, a pin 212 extends through the side portion 174 of the third frame assembly 170 and the side portion 144 of the second frame assembly 140. The pins 212 are coaxial with axis 222 so that the third frame assembly 170 and second frame assembly 140 are rotatable relative to each other about axis 222. It will be appreciated that the illustrated embodiment is exemplary only and should not be considered limiting. In this regard, the third frame assembly 170 can be rotatably coupled to the second frame assembly 140 by any suitable configuration and such configurations should be considered within the scope of the present disclosure.

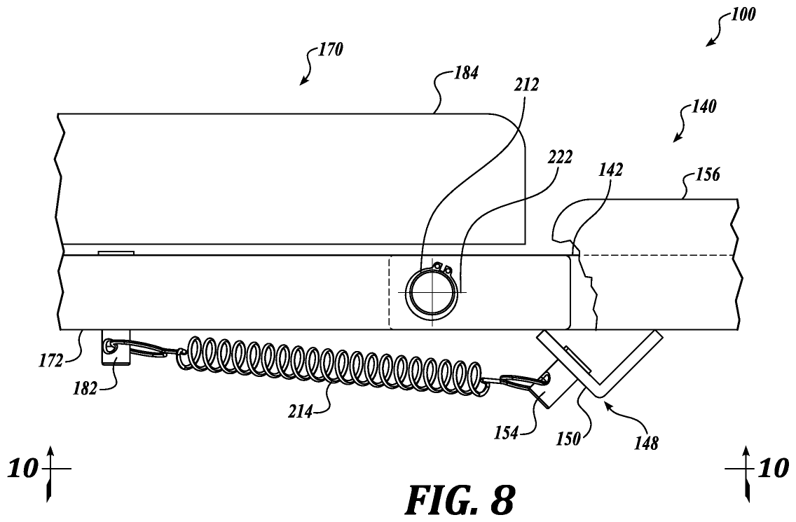

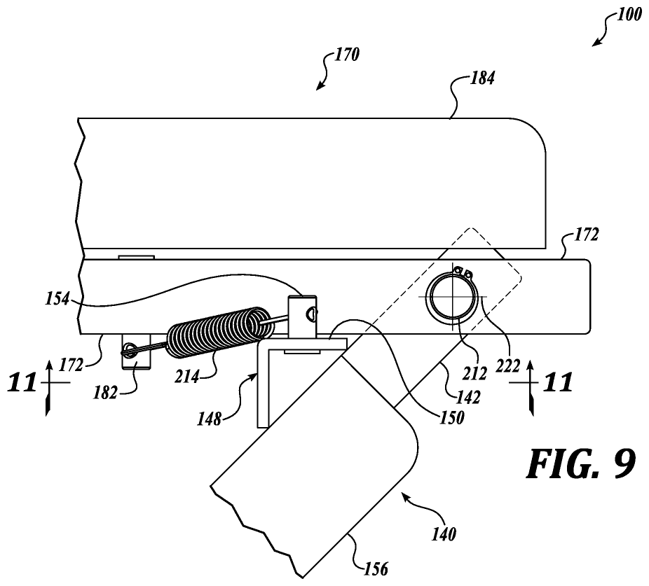

As shown in FIGS. 8 and 9, rotation of the third frame assembly 170 and the second frame assembly 140 relative to each other is limited. FIG. 8 shows a side view of the rotational connection of the third frame assembly 170 and the second frame assembly 140 when the creeper is in the first configuration of FIGS. 1-3. As shown in FIG. 8, the frame 172 of the third frame assembly 170 engages the support member 148 of the second frame assembly 140, which is fixedly secured to the side portions 144 of the frame 142, when the creeper 100 is in the second configuration. This engagement prevents the third frame assembly 170 from rotating in the clockwise direction (as shown in FIG. 8) about axis 222 relative to the second frame assembly 140. The third frame assembly 170 remains rotatable in the counter-clockwise direction (as shown in FIG. 8) about axis 222 relative to the second frame assembly 140 as the creeper 100 transitions from the first configuration to the second configuration.

As the creeper 100 transitions from the first configuration (FIG. 8) to the second configuration (FIG. 9), the second frame assembly 140 rotates relative to the first frame assembly 110 and thus, the work surface 20. During the transition, the third frame assembly 170 rotates in the counter-clockwise direction relative to the second frame assembly 140 until the frame 172 of third frame assembly 170 engages the support surface 150 of the support element 148. With the frame 172 engaging the support surface 150, further rotation of the third frame assembly 170 in the counter-clockwise direction is prevented.

Referring back to FIG. 2, when the creeper 100 is in the first configuration and positioned on the support surface 20, the first wheel assemblies 190 of the first frame assembly 110 cooperate with the second wheel assemblies 196 of the third frame assembly 170 so support the first, second, and third frame assemblies 110, 140, and 170. The first frame assembly 110 is supported in a generally horizontal position by the first wheel assemblies 190 positioned at the first end 130 and second end 132 of the first frame assembly 110. The second frame assembly 140 and the third frame assembly 170 are supported (1) at one end by the rotational attachment of the second frame assembly 140 to the first frame assembly 110, and (2) at the other end by the second wheel assemblies 196 of the third frame assembly 170.

In the first configuration, the first, second, and third frames 112, 142, and 172 of the first, second, and third assemblies 110, 140, and 170, respectively, are generally coplanar to each other and are offset from the work surface 20. The upper surfaces of the first support pad 126 and the second support pad 156 are generally coplanar with each other and the support surface 20. The upper surface of the third support pad 184 is coplanar with the support surface 20 and offset from the upper surfaces of the first and second support pads 126, 156 in a vertical direction. In the illustrated embodiment, the first, second, and third support pads 126, 156, and 184 cooperate to form a padded surface upon which a user can lie in a supine position. The first and second wheel assemblies 190, 196 enable a user to move the creeper 100 in any direction along the support surface 20 while lying on the creeper.

It will be appreciated that the illustrated embodiment is exemplary only, and the shape and position of the frame assemblies can be of any suitable configuration. In some embodiments, one or more of the frame assemblies are not coplanar with one or more of the other frame assemblies when the creeper is in the first configuration. In some embodiments, the support pads have any suitable size, contour, position, relationship to each other, etc. These and other variations are contemplated and should be considered within the scope of the present disclosure.

As shown in FIG. 5, when the creeper 100 is in the second configuration, the first wheel assemblies 190 remain in contact with the work surface 20 to maintain the first frame assembly 110 in a generally horizontal orientation above the work surface. The second frame assembly 140 has been rotated (clockwise in FIG. 5) to form an acute angle with the first frame assembly 110, and the third frame assembly 170 has been rotate (counter-clockwise in FIG. 5) to form an acute angle with the second frame assembly 140. As a result, the creeper 100 has a generally Z-shaped profile in which the third frame assembly 170 is supported by the second frame assembly 140 in a generally horizontal position above the first frame assembly 110. When the creeper 100 is so-positioned, the third support pad 184 provides an elevated surface upon which a user can sit. In the second configuration, the creeper 200 is supported by the first wheel assemblies 190, enabling a user sitting on the third support pad 184 to move the creeper 100 in any direction along the support surface 20.

Still referring to FIG. 5, when the creeper 100 is in the second configuration, the weight of the third frame assembly 170 urges the third frame assembly to rotate in the counter-clockwise direction about axis 222 so that the frame 172 of the third frame assembly maintains engagement with the support surface 150 of the second frame assembly 140 to hold the third frame assembly in the generally horizontal position. At the same time, the combined weight of the second and third frame assemblies 140, 170 urge the second frame assembly 140 to rotate in the clockwise direction about axis 220 so that the frame 142 of the second frame assembly maintains engagement with the support surface 122 of the first frame assembly 110 to hold the second frame assembly at an acute angle relative to the first frame assembly. Thus, the creeper 100 is self-supporting in the second configuration. That is, locking pins or other locking features used in known foldable creepers are not required.

Referring now to FIGS. 8-11, the creeper 100 includes a pair of springs 214 (biasing elements) that assist movement of the creeper between the first and second configurations. In the illustrated embodiment, the springs 214 and associated attachment hardware are symmetrically arranged about a central plane of the creeper. Accordingly, one spring 214 will be described with the understanding that the biasing element on the opposite side of the creeper is similarly configured.

A first pin 154 extends in a perpendicular direction from the support surface 150 of the support member 148 of the second frame assembly 140. The first pin 154 provides an attachment interface for one end of the spring 214. A second pin 182 extends downward from the bottom of the frame 172 of the third frame assembly. The second pin 182 provides an attachment interface for the other end of the spring 214. Thus, the spring 214 is coupled to both the second frame assembly 140 and the third frame assembly 170 and applies a biasing force to each frame assembly.

In the illustrated embodiment, the spring is a tension spring 214 that extends between the first pin 154 and the second pin 182. Each end of the spring 214 includes a hook that is attached to the corresponding pin by engagement of the hook with an aperture extending radially through the pin.

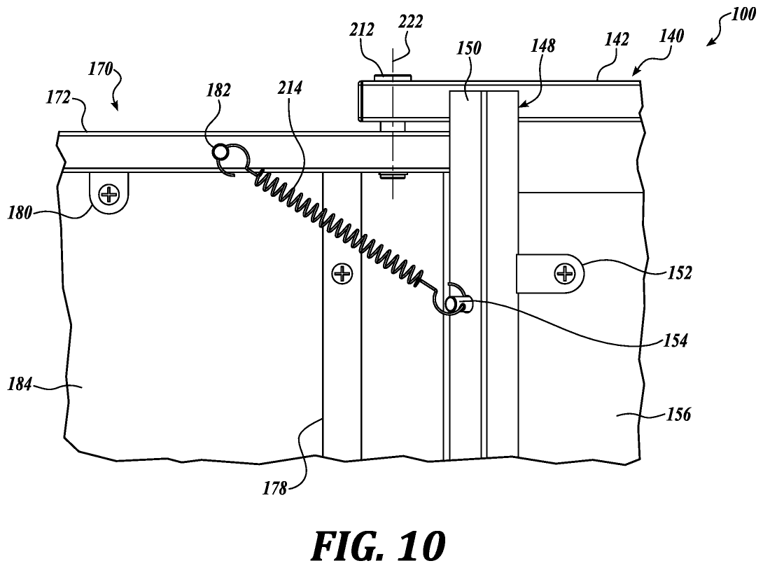

When the creeper 100 is in the first configuration, as shown in FIGS. 8 and 10, the spring 214 is in an extended state, i.e., the spring has been stretched from its natural length. The extension of the spring 214 results in a tensile force along the centerline of the spring that biases the first pin 154 and the second pin 182 toward each other.

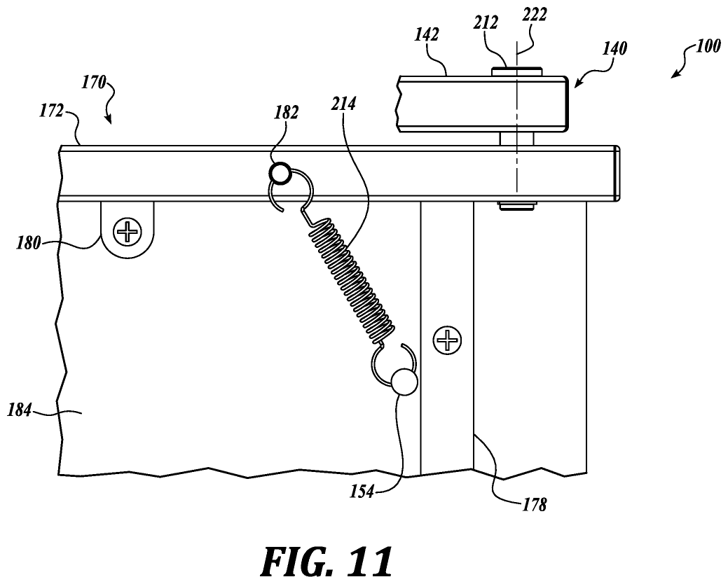

When the creeper 100 is in the second configuration, as shown in FIGS. 9 and 11, the spring 214 is in a neutral state or a less-extended state. Accordingly, the spring 214 applies a smaller tensile force to the first pin 154 and the second pin 182 than when the creeper 100 is in the first position (or zero tensile force). Because the direction of the tensile force remains along the centerline of the spring 214, the second frame assembly 140 and the third frame assembly 170 move relative to each other, the orientation of the spring and, thus, the direction of the tensile force, also changes.

The biasing elements of the illustrated embodiment are a pair of tension springs; however, it will be appreciated that the illustrated embodiment is exemplary only and should not be considered limiting. In this regard, the biasing elements can have any suitable number, position, and/or type. In some embodiments, one or more of the biasing elements is a torsion spring, a variable pitch spring, an air spring, or any other suitable spring. Further, the interface of the biasing element(s) with one or both frame assemblies may be of any suitable configuration to apply the force produced by the biasing element(s) to the second and third assemblies and such embodiments as described herein, and such embodiments should be considered within the scope of the present disclosure.

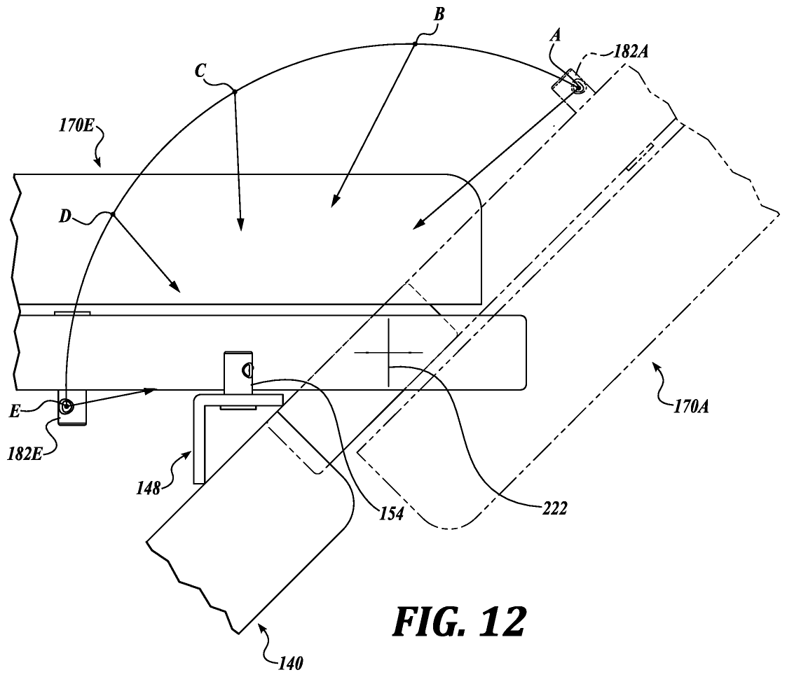

FIG. 12 shows the movement of the third frame assembly 170 and second pin 182 relative to the second frame assembly 140 and first pin 154 as the creeper 100 reciprocates between the first position (third frame assembly 170A, second pin 182A) and the second position (third frame assembly 170E, second pin 182E). As indicated by the arc, the second pin 182 travels along a constant radius path centered at the axis 222. As the pin 182 moves along the arcuate path, the direction and magnitude of the tensile spring force generated at various points is illustrated by the arrows.

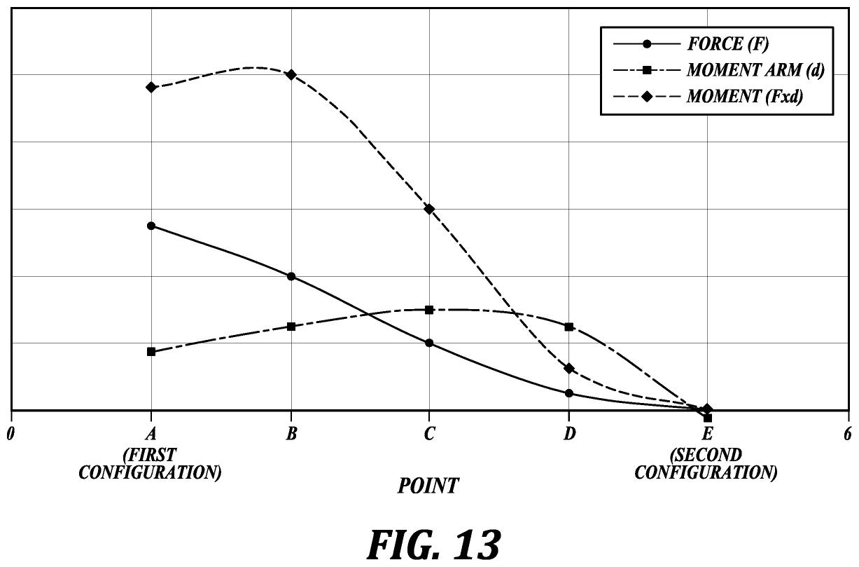

FIG. 13 shows a graph of a representative embodiment of the torque generated by the spring 214 as the creeper 100 reciprocates between the first and second configurations, as shown in FIG. 12. For each of the points A-E along the path of the second pin 182 shown in FIG. 13, FIG. 12 shows the force, moment arm, and moment resulting from the spring 214 at that point. As previously noted, the force applied by the spring 214 is generally proportional to the extension of the spring, i.e., the distance between the first pin 154 and the second pin 182. The moment arm is the perpendicular distance between the vector of the force and axis 222. The moment generated by the spring, which represents the turning effect of the force, is defined by the following equation:

$$Moment = Force \times Moment Arm \qquad ( 1 )$$

Referring to FIGS. 12 and 13, as the creeper 100 moves from the first configuration (point A) to the second configuration (point E), the force decreases at a generally linear rate from a maximum force to a minimum force. The offset of the first pin 154 from the axis 222 of rotation produces a moment arm that increases slowly from an initial value in the first configuration and then decreases more rapidly to have a value of approximately 0 in the second configuration. The resulting moment, which urges the third frame assembly 170 toward the second configuration, is largest between points A and B. After the third frame assembly 170 passes through point B, the moment decreases in a generally linear manner until the third frame assembly 170 passes through point D. The moment continues to decrease at a decreasing rate until the frame assembly 170 reaches point E, at which point the value of the moment is approximately 0.

It will be appreciated that the illustrated force, moment arm, and moment profiles generated by the spring 214 as the creeper 100 reciprocates between the first and second configurations are exemplary only and should not be considered limiting. It will be appreciated that the position of the first pin 154 and second pin 182 relative to each other and to the axis 222 can be modified to produce different force and moment arm profiles that in turn results in a desired moment profile.

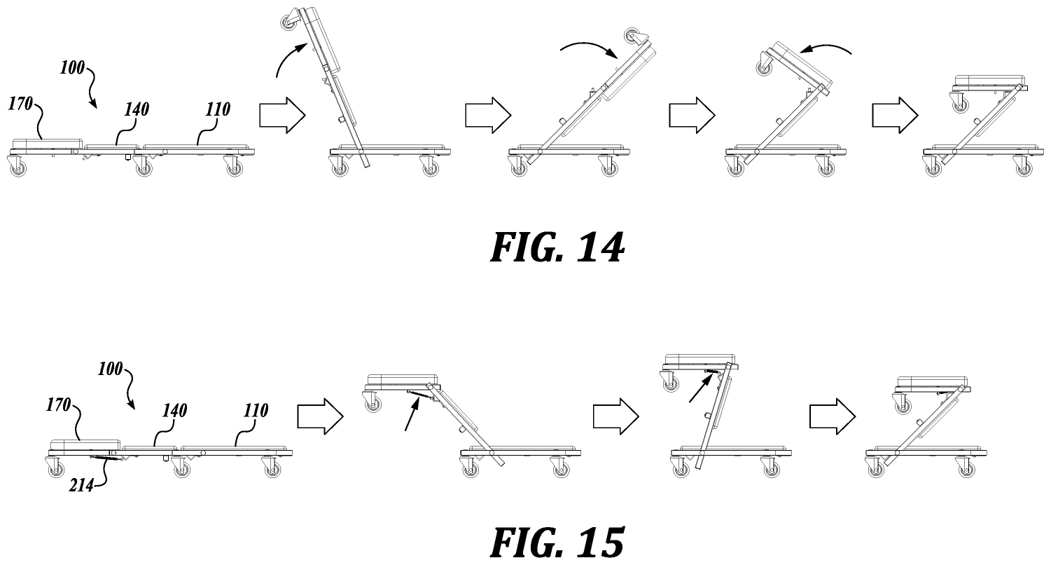

The moment generated by the springs 214 assists a user reciprocating the creeper 100 between the first and second configurations, particularly when moving the creeper from the first configuration to the second configuration. FIGS. 14 and 15 show the creeper 100 from the first configuration to the second configuration (1) with the springs 214 removed (FIG. 14) and (2) with the springs 214 installed (FIG. 15).

As shown in FIG. 14, when the springs 214 are removed from the creeper 100, the creeper moves from the first configuration to the second configuration in a manner similar to known folding creepers. Moving from left to right in FIG. 14, the creeper 100 starts in a flat first configuration in which the first, second, and third frame assemblies 110, 140 and 170 are generally aligned to form a flat support surface. To move the creeper to the second configuration, a user holds the second end 188 of the third frame assembly 170 and rotates the second and third frame assemblies 140 and 170 in unison about axis 220, i.e., the axis about which the first and second frame assemblies 110 and 140 are rotationally coupled to each other (in a clockwise direction as shown in FIG. 14). Rotation of the second and third frame assemblies 140, 170 continues in the clockwise direction until the second frame assembly 140 engages the support surface 122, which prevents further clockwise rotation.

The user then rotates the third frame assembly 170 relative to the second frame assembly 140 in the counterclockwise direction (as viewed in FIG. 14) about axis 222, i.e., the axis about which the second frame assembly 140 is rotatably coupled to the third frame assembly 170. The second frame assembly 140 remains engaged with support surface 122, and the third frame assembly 170 continues to rotate until the third frame assembly 170 contacts support surface 150, which prevents further counter-clockwise rotation. With the second frame assembly 140 engaged with support surface 122 and the third frame assembly 170 engaged with the support surface 150, the creeper 100 has reached the second configuration.

Referring now to FIG. 15, when the springs 214 are mounted to the creeper 100, a user is able to transition the creeper from the first configuration to the second configuration with a single motion. To move the creeper 100 from the first configuration to the second configuration, a user moves the second end 188 of the third frame assembly 170 in an arcuate path about axis 220 (clockwise as shown in FIG. 15). As the second and third frame assemblies 140 and 170 rotate about axis 220 relative to the first frame assembly 110, the moment generated by the springs 214 urges the second and third frame assemblies 140 and 170 to rotate relative to each other about axis 222. About the time that the second frame assembly 140 contacts support surface 122, third frame assembly 170 contact support surface 150. Thus, by assisting with rotation of the second and third frame assemblies 140 and 170 relative to each other, the springs 214 enable a user to easily move the creeper 100 to the second configuration in a single motion using just one hand to move the second end 188 of the third frame assembly 170.

The detailed description set forth above in connection with the appended drawings is intended as a description of exemplary embodiments of the disclosed subject matter and is not intended to represent the only embodiments. The exemplary embodiments described in this disclosure are provided merely as examples or illustrations of a multi-configuration apparatus, such as a creeper, and should not be construed as preferred or advantageous over other embodiments. The illustrative examples provided herein are not intended to be exhaustive or to limit the disclosure to the precise forms disclosed. Similarly, any features and/or process steps described herein may be interchangeable with other features and/or process steps, or combinations of features and/or process steps, in order to achieve the same or substantially similar result.

In the foregoing description, numerous specific details are set forth in order to provide a thorough understanding of the exemplary embodiment of the present disclosure. It will be apparent to one skilled in the art, however, that many embodiments of the present disclosure may be practiced without some or all of the specific details. In some instances, well-known features, subassemblies, and/or process steps have not been described in detail in order not to unnecessarily obscure various aspects of the present disclosure. Further, it will be appreciated that embodiments of the present disclosure may employ any combination of features described herein. For instance, any feature or configuration described above with respect to the core may be adapted for use with the cover, and vice versa.

The present disclosure also includes references to directions, such as “vertical”, “horizontal,” “proximal,” “distal,” “upper,” “lower,” “upward,” “downward,” “top,” “bottom,” “first,” “second,” etc. These references and other similar references in the present disclosure are only to assist in helping describe and understand the exemplary embodiments and are not intended to limit the claimed subject matter to these directions.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. The terms “substantially,” “about,” “approximately,” etc., mean plus or minus 5% of the stated value.

While illustrative embodiments have been illustrated and described, it will be appreciated that various changes can be made therein without departing from the spirit and scope of the disclosure.

The embodiments of the invention in which an exclusive property or privilege is claimed are defined as follows:

1. A creeper, comprising:
a first frame assembly;
a second frame assembly rotatably coupled at a first end to a first end of the first frame assembly about a first axis;
a third frame assembly rotatably coupled at a first end to a second end of the second frame assembly about a second axis; and
a biasing element operatively associate with the second and third frame assemblies,
wherein rotation of the second frame assembly about the first axis in a first direction and rotation of the third frame about the second axis in a second direction opposite the first direction moves the creeper from a first configuration to a second configuration, the biasing element urging the third frame assembly to rotate in the second direction.

2. The creeper of claim 1, wherein the first frame assembly, the second frame assembly, and the third frame assembly are parallel when the creeper is in the first configuration.

3. The creeper of claim 2, wherein the third frame assembly is positioned above and parallel to the third frame assembly when the creeper is in the second configuration.

4. The creeper of claim 1, wherein the creeper has a flat profile in the first configuration and a Z-shaped profile in the second configuration.

5. The creeper of claim 4, wherein the first frame assembly includes a first support surface that engages the second frame assembly when the creeper is in the second configuration, engagement of the first support surface with the second frame assembly preventing rotation of the second frame assembly in the first direction about the first axis.

6. The creeper of claim 5, wherein the first frame assembly includes a first support member fixedly coupled to a first frame, the first support surface forming part of the first support member.

7. The creeper of claim 6, wherein the second frame assembly engages the first support member when the creeper is in the first configuration, engagement of the second frame assembly with the first support member preventing rotation of the second frame assembly in the second direction.

8. The creeper of claim 7, wherein the second frame assembly includes a second support surface that engages the third frame assembly when the creeper is in the second configuration, engagement of the second support surface with the third frame assembly preventing rotation of the third frame assembly in the second direction about the second axis.

9. The creeper of claim 8, wherein the second frame assembly includes a second support member fixedly coupled to a second frame, the second support surface forming part of the second support member.

10. The creeper of claim 9, wherein the third frame assembly engages the second support member when the creeper is in the first configuration, engagement of the third frame assembly with the support member preventing rotation of the third frame assembly in the first direction.

11. The creeper of claim 1, wherein the second frame assembly includes a support surface that engages the third frame assembly when the creeper is in the second configuration, engagement of the support surface with the third frame assembly preventing rotation of the third frame assembly in the second direction about the second axis.

12. The creeper of claim 11, wherein the second frame assembly includes a support member fixedly coupled to a second frame, the support surface forming part of the support member, wherein the third frame assembly engages the support member when the creeper is in the first configuration, engagement of the third frame assembly with the support member preventing rotation of the third frame assembly in the first direction about the second axis.

13. The creeper of claim 1, wherein the second frame assembly includes a first spring interface, the third frame assembly includes a second spring interface, and the biasing element is a tension spring coupled at one end to the first spring interface and at a second end to the second spring interface.

14. The creeper of claim 13, wherein movement of the creeper from the first configuration to the second configuration stretches the tension spring.

15. The creeper of claim 14, wherein the tension spring is at a natural length when the creeper is in the second configuration.
